(19) United States
(12) Patent Application Publication
(10) Pub. No.: US 2006/0184676 A1
(43) Pub. Date: Aug. 17, 2006

(54) Image communication device

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/314,552

(22) Filed: Dec. 20, 2005

(30) Foreign Application Priority Data
Feb. 16, 2005 (JP) 2005-038666
Feb. 23, 2005 (JP) 2005-046502

(51) Int. Cl. G06F 15/16

(52) U.S. Cl. 709/227; 709/228

(57) ABSTRACT

Even when an SIP server imposes a restriction on a description content of an SDP, an image communication device can freely define a content of a media session with another end without receiving the restriction. Even when the image communication device is connected to a carrier network set for a purpose of only a usage of voice communication, the image communication device can carry out communication of image data or transmission of a character string. An image communication device establishes a media session by exchanging a message of a call control protocol with a communication device of another end and transmits image data. The image communication device describes information relating to the media session to be requested to the communication device of the other end or a character string to be transmitted to the communication device of the other end in a field not interfered by a call control server.

### BACKGROUND OF THE INVENTION

1. Field of the Invention

The present invention relates to an image communication device which transmits and receives image data by using a call control protocol such as a Session Initiation Protocol (SIP).

2. Description of the Related Art

A recently proposed Internet Protocol (IP) facsimile machine establishes a media session by the SIP and transmits and receives image data. In order to establish the media session, a calling side machine and a called side machine exchange a text-based signaling message. In the exchange of the signaling message, a media type, a Coder-Decoder (CODEC), an IP address and a port number or the like to be adopted in the media session are defined. The abovementioned information relating to the media session is generally described by a Session Description Protocol (SDP).

In the same manner as a Group 3 (G3) facsimile machine, the above-described IP facsimile machine can designate destination information by a telephone number. Therefore, a user can perform a transmission operation of the IP facsimile machine in the same manner as when performing a transmission operation of the G3 facsimile machine. In addition, the IP facsimile machine has an advantage that the communication costs can be saved compared with the G3 facsimile machine.

Originally, an SIP server is involved in a call control and is not involved in a content of the media session or a description content described by the SDP. However, the IP facsimile machine, which transmits and receives image data by using the SIP, has not become widespread yet. Accordingly, many SIP servers of a carrier include an installation based on a purpose for only a usage of voice communication by an IP telephone. That is, many SIP servers accept a call control processing for only a request message in which a specific content is described by the SDP, and do not accept a call control processing for a request message or the like in which a specific content is not described by the SDP. For example, when an SIP server of the carrier is set to accept a call control processing for only a request message in which “m=audio 5004 RTP/AVP0” is described by the SDP, even if an IP facsimile machine is provided on a network of the carrier, the SIP server rejects a forward processing of a request message in which a communication request of image data is described by the SDP. As a result, there exists a drawback that a media session for transmitting image data to another end cannot be established.

In facsimile communication, a user at a receiving side can recognize an incoming call by a ringing tone, an incoming call display or the like. However, regarding a content of an original document being received, the user cannot obtain information of the content at all until a reception processing has been completed and the content is printed out onto printing paper or the like. This fact has caused inconvenience to the user. In particular, during a reception of an original document including a plurality of pages, for example, 50 pages or 100 pages, the user becomes curious about the content of the original document being received. In addition, when the original document being received includes a large number of pages, the user becomes anxious about the printing papers being wasted by printing out the received data.

If information relating to the original document, for example, information such as a title, a number of pages and a transmitter of the original document, is displayed on a display unit of a receiving side machine during the communication, the abovementioned inconveniences are solved. However, a proposal for such a function has not been made for the IP facsimile machine using the call control protocol such as the SIP.

### SUMMARY OF THE INVENTION

In order to overcome the problems described above, an advantage of the present invention is to provide an image communication device which can freely define a content of a media session with another end without receiving a restriction even when a server controlling a call control imposes a restriction on a description content of an SDP, and which can carry out communication of image data by using a call control protocol even when the image communication device is connected to a carrier network designed for only a usage of voice communication.

Another advantage of the present invention is to provide an image communication device which can notify a user as to a content of a character string transmitted and received during communication carried out between image communication devices, such as IP facsimile machines, by using the call control protocol such as the SIP.

According to an aspect of the present invention, an image communication device establishes a media session with a communication device of another end by exchanging a message of a call control protocol, and transmits image data. The image communication device includes a storage unit, a first description unit and a second description unit. The storage unit stores an SDP header format that conforms to a server of a carrier to which the image communication device is connected. The first description unit describes an SDP header of a transmission request message in accordance with the SDP header format stored in the storage unit. The second description unit describes information relating to the media session, which is to be actually requested to the other end, in a prescribed area of the request message not interfered by the server.

The prescribed area where the second description unit describes the information relating to the media session is a specific field for example, an s field, in the SDP header described by the first description unit.

According to another aspect of the present invention, an image communication device establishes a media session with a communication device of another end by exchanging a message of a call control protocol, and receives image data. The image communication device includes an information adopting unit which adopts information described in a prescribed area of a received request message not interfered by a server controlling a call control as information relating to the media session requested by the other end.

The prescribed area not interfered by the server is a specific field, for example, an s field, in the SDP header of the received request message.

According to another aspect of the present invention, an image communication device establishes a media session with a communication device of another end by exchanging a message of a call control protocol, and transmits image data. The image communication device includes an input unit, a description unit and a transmission unit. The input unit inputs any arbitrary character string. The description unit describes the input character string in a prescribed area, which does not influence the establishment of the media session, in a message requesting the establishment of the media session. The transmission unit transmits the message including the character string to the other end.

The image communication device further includes a storage unit which stores the character string described in the prescribed area as communication history information.

According to another aspect of the present invention, an image communication device establishes a media session with a communication device of another end by exchanging a message of a call control protocol, and receives image data. The image communication device includes an extracting unit and an output unit. The extracting unit extracts a character string described in a prescribed area, which does not influence the establishment of the media session, in a message requesting the establishment of the media session received from the other end. The output unit outputs the extracted character string.

The image communication device further includes a storage unit which stores the character string described in the prescribed area as communication history information.

According to the above-described image communication device, even when a server controlling a call control imposes a restriction on a description content of the SDP, the image communication device can freely define a content of the media session without receiving the restriction. Accordingly, even in case of using a carrier network designed for only a usage of a specific media type, for example, voice communication, the image communication device can establish a media session with the communication device of the other end and transmit and receive image data or a character string.

The information relating to the media session, which is to be actually requested to the other end, is described in a specific field of the SDP header not interfered by the server controlling the call control. Therefore, even when a request message including such information is transmitted, the call control carried out by the server is not adversely influenced.

According to the above-described image communication device, any arbitrary character string is transmitted from a calling side to a called side, and the character string is output at the called side. Therefore, when information relating to an original document is input from a calling side machine, a user of a called side machine can learn the information relating to the original document from the output character string even while the original document is being received.

After the image data of the original document is transmitted and received, the character string transmitted from the calling side to the called side is stored as communication history information of the original document in both the calling side machine and the called side machine. For example, if information relating to a transmission original document is input at the calling side machine, by using a character string (information relating to the original document) stored as communication history information, a management of a communication history can be facilitated later for various original documents.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an example of a configuration or the like of a facsimile machine (image communication device) according to a first preferred embodiment of the present invention.

FIG. 2 illustrates an example of a table according to the first preferred embodiment of the present invention.

FIG. 3 is a sequence diagram illustrating a communication protocol formed between a calling side facsimile machine (image communication device) and a called side facsimile machine (image communication device) and an SIP server according to the first preferred embodiment of the present invention.

FIG. 4 is a flowchart illustrating a processing operation executed when the facsimile machine (image communication device) carries out a transmission operation according to the first preferred embodiment of the present invention.

FIG. 5 is a flowchart illustrating a processing operation executed when the facsimile machine (image communication device) receives “INVITE”, which is a request for establishing a media session, according to the first preferred embodiment of the present invention.

FIG. 6 is a sequence diagram illustrating a communication protocol formed between the calling side facsimile machine (image communication device) and the called side facsimile machine (image communication device) and SIP servers according to the first preferred embodiment of the present invention. FIG. 6 illustrates an example in which two SIP servers are provided.

FIG. 7 illustrates an example of a configuration or the like of a facsimile machine (image communication device) according to a second preferred embodiment of the present invention.

FIG. 8 is a sequence diagram illustrating a communication protocol formed between a calling side machine and a called side machine.

FIG. 9 is a flowchart illustrating a processing operation executed by the calling side machine (image communication device) when the calling side machine receives a transmission instruction of image data using the SIP according to the second preferred embodiment of the present invention.

FIG. 10 is a flowchart illustrating a processing operation executed by the called side machine (image communication device) when the called side machine receives a message requesting an establishment of a media session according to the second preferred embodiment of the present invention.

FIG. 11 is a sequence diagram illustrating a communication protocol formed between the calling side machine and the called side machine. FIG. 11 illustrates a communication protocol when any arbitrary character string is exchanged during data communication of image data or the like.

### DETAILED DESCRIPTION OF PREFERRED EMBODIMENTS

### First Preferred Embodiment

A description will be made of an image communication device according to a first preferred embodiment of the present invention. A description will be made of an example of a Multi Function Peripheral (MFP) facsimile machine including an IP facsimile communication function for transmitting and receiving image data of an original document by using a call control protocol, a G3 facsimile communication function, and a facsimile server function for carrying out various facsimile communications according to a request from a client device, or the like.

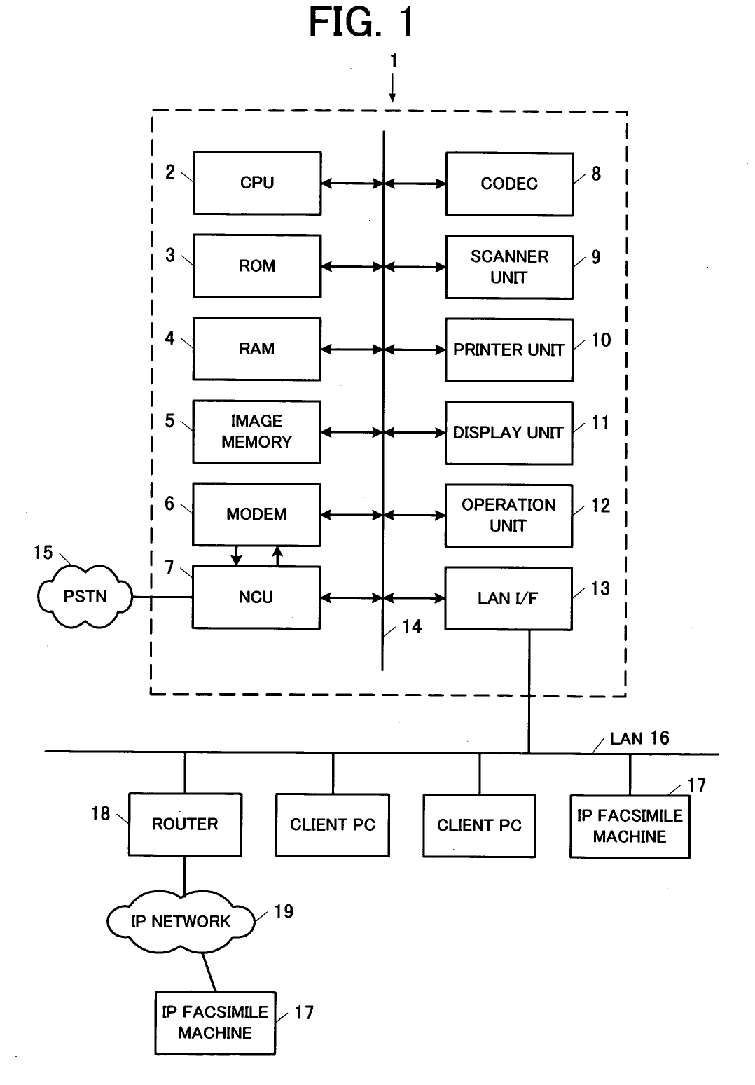

FIG. 1 illustrates an example of a configuration of a facsimile machine 1. The facsimile machine 1 includes a Central Processing Unit (CPU) 2, a Read Only Memory (ROM) 3, a Random Access Memory (RAM) 4, an image memory 5, a Modulator-Demodulator (MODEM) 6, a Network Control Unit (NCU) 7, a Coder-Decoder (CODEC) 8, a scanner unit 9, a printer unit 10, a display unit 11, an operation unit 12 and a Local Area Network (LAN) interface 13. Each of the units 2 through 13 is connected via a bus 14.

The CPU 2 functions as a control unit for controlling each of the units of the facsimile machine 1 in accordance with a control program stored in the ROM 3. The RAM 4 functions as a main memory, a working area or the like of the CPU 2. The RAM 4 stores a table X described hereinafter. The image memory 5 stores image data compressed and encoded by the CODEC 8, for example.

The MODEM 6 modulates transmission data and demodulates received data in accordance with the International Telecommunication Union-Telecommunications (ITU-T) Recommendation V.34 standard or anything similar to this, for example. The NCU 7 is a communication network control device which carries out an operation for making and breaking a communication line with a Public Switched Telephone Network (PSTN) 15. When carrying out G3 facsimile transmission or reception, the NCU 7 establishes a connection between the MODEM 6 and the PSTN 15. When carrying out facsimile transmission or the like, the CODEC 8 compresses and encodes image data by the Joint Photographic Experts Group (JPEG) method or the Modified Huffman (MH), the Modified Read (MR) or the Modified MR (MMR) method or the like. The CODEC 8 also decodes received image data or the like.

The scanner unit 9 scans image data of an original document. For example, the scanner unit 9 includes a Charge-Coupled Device (CCD) color line image sensor, an Analog-to-Digital (A/D) converter and an image processing circuit or the like. The printer unit 10 picks up printing paper from a paper feed cassette and prints the image data onto the printing paper. The display unit 11 includes a Liquid Crystal Display (LCD) arranged adjacent to the operation unit 12, for example. The display unit 11 displays various pieces of screen information. The operation unit 12 includes various operation keys such as a start key, a character input key and a function key. A user carries out various operations from the operation unit 12.

The LAN interface 13 is an interface for establishing a connection between the facsimile machine 1 and a LAN 16. Through the LAN interface 13, the facsimile machine 1 can establish a media session by an SIP with an IP facsimile machine 17, which is also connected to the LAN 16 and includes a call control protocol or the like, and transmit and receive image data to and from the IP facsimile machine 17. Through the LAN interface 13, the facsimile machine 1 can also establish a media session by the SIP with another IP facsimile machine 17, which is provided on an IP network 19, through a router 18 and transmit and receive image data to and from the IP facsimile machine 17.

The facsimile machine 1 having the above-described configuration includes a Transmission Control Protocol/Internet Protocol (TCP/IP), the SIP, a Real-time Transport Protocol (RTP), an SDP or the like. Accordingly, the facsimile machine 1 realizes a function for transmitting and receiving image data to and from another end after establishing a media session by the SIP. In the first preferred embodiment, a description will be made of an example of the SIP as the call control protocol. However, the present invention shall not be limited to this example. A call control protocol other than the SIP may be adopted if the call control protocol exchanges a text-based request and a text-based response message with the other end prior to the establishment of the media session and exchanges information relating to the media session by the SDP.

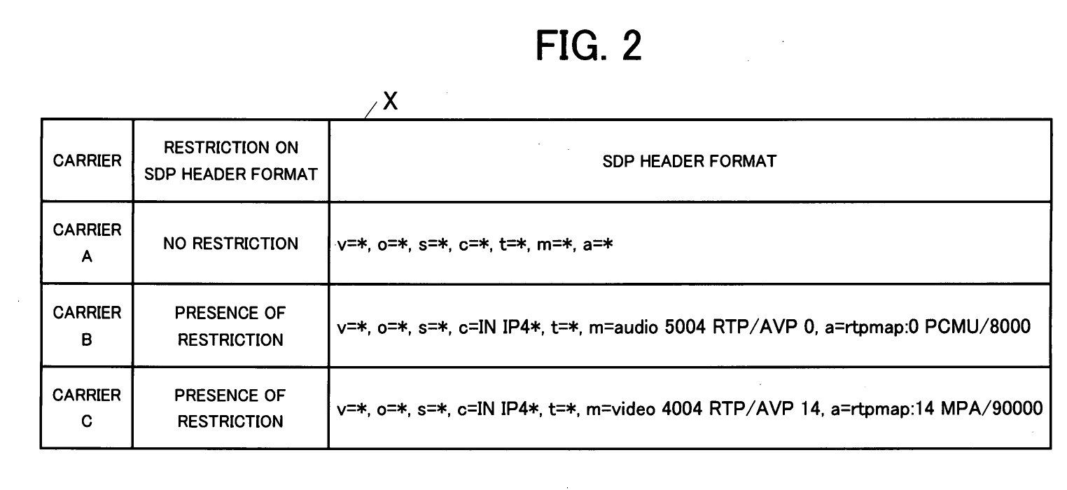

The RAM 4 of the facsimile machine 1 stores information indicating a presence or an absence of a restriction on an SDP header format for each carrier, and an SDP header format that conforms to an SIP server of a carrier having the restriction. Specifically, as illustrated in table X of FIG. 2, for example, “presence of restriction” or “no restriction” is stored as the information indicating the presence or the absence of the restriction on the SDP header format. As the SDP header format that conforms to the SIP server of each carrier, for example, “v=*, o=*, s=*, c=IN IP4*, t=*, m=audio 5004 RTP/AVP 0, a=rtpmap:0 PCMU/8000” illustrated in FIG. 2 is stored for each carrier. “*” is information indicating that a restriction is not imposed on a description content.

In the first preferred embodiment of the present invention, information relating to the media session, which is to be actually requested or responded to the other end, is described in a specific field, for example, an “s” field, not interfered by the SIP server. Further, the presence or the absence of the restriction on the SDP header format and the SDP header format that conforms to the SIP server of the carrier can be grasped from a specification or the like provided by the carrier (communication carrier). The information of table X is registered previously when the facsimile machine 1 is shipped from a factory or registered by a prescribed operation or the like performed by the user of the facsimile machine 1.

The facsimile machine 1 also includes a setting unit for setting a carrier to which the facsimile machine 1 will be connected among carriers stored in table X by a prescribed operation performed from the operation unit 12 or the like. Suppose that either one of the carriers, for example, a “carrier B”, is set as the carrier to which the facsimile machine 1 will be connected. Then, when the facsimile machine 1 transmits and receives image data by using the SIP, the facsimile machine 1 describes an SDP header in a signaling message in accordance with the SDP header format registered by being associated with the “carrier B” in table X. Furthermore, the facsimile machine 1 describes information relating to a media session, which is to be actually requested or responded to the other end, in the “s” field not interfered by the SIP server.

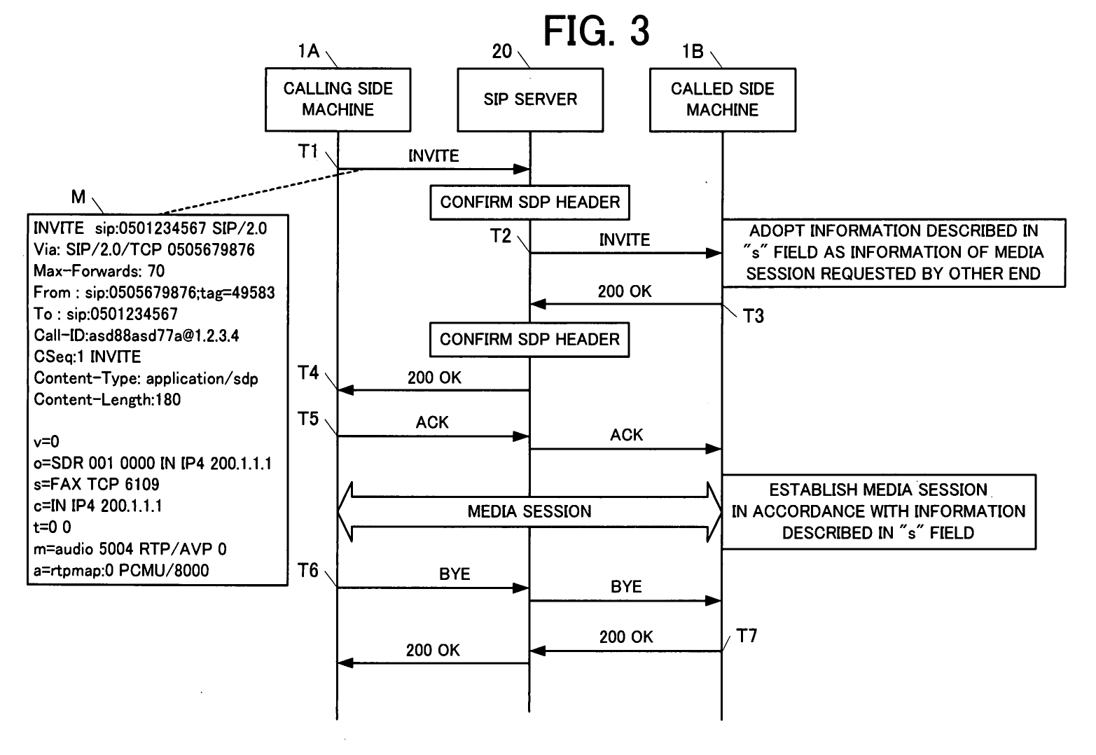

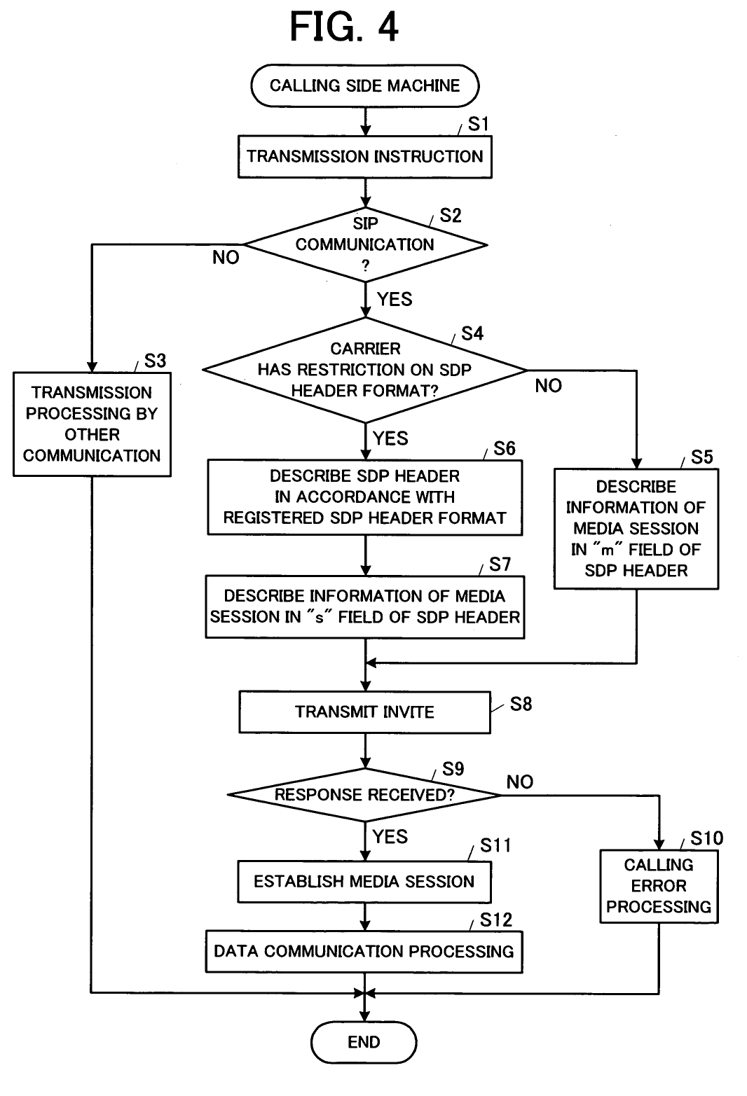

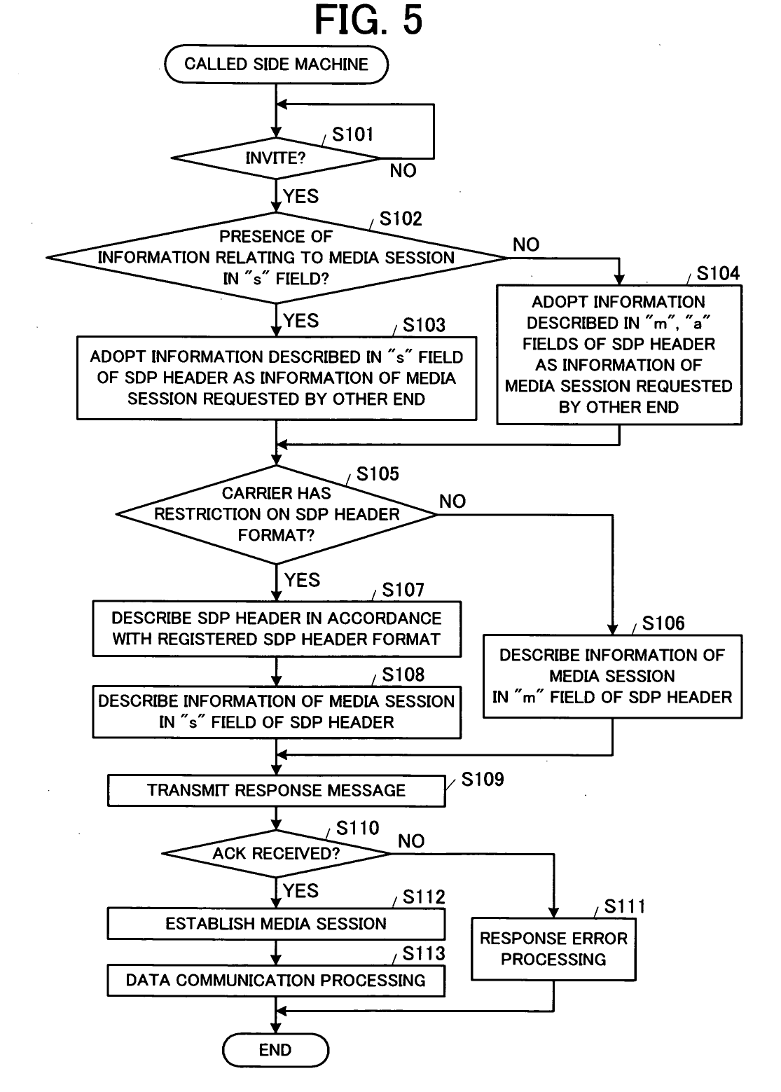

Next, with reference to the sequence diagram of FIG. 3 and the flowcharts of FIG. 4 and FIG. 5, a description will be made of a processing operation executed when the facsimile machines 1 having the above-described configuration and the communication function establish a media session between one another by the SIP and transmit and receive image data. Further, the processing operation of the facsimile machines 1 to be described with reference to FIG. 3 through FIG. 5 is executed in accordance with a command issued by the CPU 2, which is the control unit, based on the control program stored in the ROM 3. In the following, for convenience of the description, the facsimile machine 1 to be a calling side will be referred to as a “calling side machine 1A” and the facsimile machine 1 to be a called side will be referred to as a “called side machine 1B”.

When transmission of image data using the SIP or transmission of image data by other communication not using the SIP is instructed from the operation unit 12 or the like of the facsimile machine 1 (the calling side machine 1A) (step S1), in case of transmitting the image data by the other communication not using the SIP (step S2: NO), a transmission processing of the image data is carried out by the other communication not using the SIP, for example, G3 facsimile (step S3).

In case of transmitting the image data by using the SIP (step S2: YES), the calling side machine 1A determines whether or not an SIP server 20 of a carrier to which the calling side machine 1A is connected directly imposes a restriction on the SDP header format in accordance with the information registered in table X (step S4). For example, when “*” is registered for all of the fields, as illustrated in table X, and a restriction is not imposed on the description content, the calling side machine 1A determines that the SIP server 20 to which the calling side machine 1A is connected directly does not impose a restriction on the SDP header format (step S4: NO). The calling side machine 1A generates a request message “INVITE” in which information relating to the media session, which is to be actually requested to the other end, or the like is described according to a description rule of the SDP (step S5). That is, the calling side machine 1A describes the information relating to the media session, which is to be requested to the other end, in “m” and “a” fields of the SDP header. The calling side machine 1A does not describe the information relating to the media session or the like in “v”, “s” and “t” fields or the like of the SDP header, which are fields not used generally in the SIP.

Meanwhile, when the calling side machine 1A determines that the SIP server 20 to which the calling side machine 1A is connected directly imposes a restriction on the SDP header format (step S4: YES), the calling side machine 1A describes an SDP header in the request message “INVITE” as illustrated in FIG. 3, for example, in accordance with the SDP header format stored in table X by being associated with the carrier set as the carrier to which the calling side machine 1A is connected (step S6). In addition, the calling side machine 1A describes the information relating to the media session, which is to be actually requested to the other end, in the “s” field of the SDP header not interfered by the SIP server 20 (step S7). After the processing operation of step S5 or step S7, the generated request message “INVITE” is transmitted to the other end (step S8, T1). Further, “FAX” described in the “s” field of the SDP header described in a request message M illustrated in FIG. 3 designates image data communication as a media type.

The request message “INVITE” transmitted from the calling side machine 1A as described above is received by the SIP server 20 of the carrier. When the SIP server 20 imposes a restriction on the SDP header format, a determination is carried out as to whether or not the SDP header of the request message conforms to a specific format requested by the SIP server 20. When the SDP header of the request message conforms to the specific format requested by the SIP server 20, the SIP server 20 forwards the request message to the other end (T2). Meanwhile, when the SDP header of the request message does not conform to the specific format requested by the SIP server 20, an error message is returned to the calling side machine 1A and the request message is not forwarded to the other end.

When the calling side machine 1A that transmitted the request message “INVITE” at step S8 receives an error message from the SIP server 20 without receiving a response message from the called side machine 1B, which is the other end (step S9: NO), the calling side machine 1A carries out a prescribed calling error processing (step S10). For example, the calling side machine 1A records communication error information in a log file. Alternatively, the display unit 11 of the calling side machine 1A displays a character string for notifying the user that “INVITE” did not pass the SIP server 20. For example, the character string is a message “Communication Error: Please confirm whether the set carrier is a carrier to which this machine is connected.” Alternatively, the printer unit 10 of the calling side machine 1A prints out the character string.

When the called side machine 1B receives the request message “INVITE” transmitted at step S8 from the calling side machine 1A through the SIP server 20 (step S101: YES), the called side machine 1B determines whether or not the information relating to the media session is described in the “s” field, which is a prescribed area not interfered by the SIP server 20, in the SDP header of the received request message “INVITE” (step S102). When the “s” field includes the information relating to the media session, for example, as illustrated in FIG. 3, “FAX” as information indicating a media type, “TCP” as information indicating a distinction between the UDP and the TCP and “6109” as information indicating a port number, the called side machine 1B determines that the information relating to the media session is described in the “s” field (step S102: YES). The called side machine 1B adopts this information as the information relating to the media session requested by the calling side machine 1A. The called side machine 1B does not adopt information described in the “m”, “a” fields or the like of the SDP header, where the information relating to the media session is originally required to be described according to the rule of the SDP, and destroys the information (step S103).

Meanwhile, when the called side machine 1B determines that the information relating to the media session is not described in the “s” field of the SDP header of the received request message “INVITE” (step S102: NO), the called side machine 1B adopts the information described in “m”, “a” fields or the like of the SDP header as the information relating to the media session requested by the calling side machine 1A (step S104).

Next, the called side machine 1B determines whether or not the SIP server 20 of the carrier to which the called side machine 1B is connected directly imposes a restriction on the SDP header format in accordance with the information registered in table X (step S105). When a determination is made that the SIP server 20 to which the called side machine 1B is connected directly does not impose a restriction on the SDP header format (step S105: NO), the called side machine 1B generates a response message “200 OK” in which the information relating to the media session or the like, which is to be actually replied to the calling side machine 1A, is described in accordance with the description rule of the SDP (step S106). That is, the called side machine 1B describes the information relating to the media session, which is to be replied to the calling side machine 1A, in the “m”, “a” fields of the SDP header. The called side machine 1B does not describe the information relating to the media session or the like in “v”, “s”, “t” fields or the like of the SDP header, which are fields not used generally in the SIP.

Meanwhile, when a determination is made that the SIP server 20 to which the called side machine 1B is connected directly imposes a restriction on the SDP header format (step S105: YES), the called side machine 1B describes the SDP header of the response message “200 OK” in accordance with the SDP header format stored in table X by being associated with the carrier set as the carrier to which the called side machine 1B is connected (step S107). Then, the called side machine 1B describes the information relating to the media session, which is to be actually replied to the other end, in the “s” field of the SDP header, which is the field not interfered by the SIP server 20 (step S108). After the processing operation of step S106 or step S108, the generated response message “200 OK” is transmitted to the calling side machine 1A (step S109, T3).

When the SIP server 20 receives the response message “200 OK” from the called side machine 1B, in case the SIP server 20 imposes a restriction on the SDP header format, the SIP server 20 determines whether or not the SDP header of the response message “200 OK” conforms to a format requested by the SIP server 20. When the SDP header of the response message “200 OK” conforms to the format requested by the SIP server 20, the SIP server 20 forwards the response message “200 OK” to the calling side machine 1A (T4). Meanwhile, when the SDP header of the response message “200 OK” does not conform to the format requested by the SIP server 20, an error message is returned to the called side machine 1B and the response message “200 OK” is not forwarded to the calling side machine 1A.

After the called side machine 1B transmits the response message “200 OK” at step S109, when the called side machine 1B receives the error message from the SIP server 20 without receiving an acknowledgement “ACK” of a final response from the calling side machine 1A, which is the other end (step S110: NO), the called side machine 1B carries out a prescribed response error processing (step S111). For example, the called side machine 1B records response error information in a log file. Alternatively, the display unit 11 of the called side machine 1B displays a character string for notifying the user that the response message “200 OK” failed to pass the SIP server 20 and that an error has generated. For example, the character string is a message “Response Error: Please confirm whether the set carrier is a carrier to which this machine is connected.” Alternatively, the printer unit 10 of the called side machine 1B prints out the character string.

Meanwhile, when the calling side machine 1A receives the response message “200 OK” transmitted at step S109 by the called side machine 1B via the SIP server 20 (step S9: YES), the calling side machine 1A transmits a final response acknowledgment “ACK” to the called side machine 1B (T5). The called side machine 1B receives the acknowledgement “ACK” (step S110: YES). Next, a media session is established between the calling side machine 1A and the called side machine 1B (step S11, step S112). Then, data communication processing of image data or the like is carried out (step S12, step S113). After the data communication processing has been completed, a request message “BYE” is transmitted from the calling side machine 1A via the SIP server 20 to the called side machine 1B (T6). After a response message “200 OK” is returned from the called side machine 1B via the SIP server 20 to the calling side machine 1A (T7), the media session is disconnected.

According to the first preferred embodiment of the present invention, when an SIP server to which a facsimile machine is connected imposes a restriction on an SDP header format, information relating to a media session to be requested or replied to another end is described in an “s” field of an SDP header not interfered by the SIP server. However, if the area where the information relating to the media session is described is an area not interfered by the SIP server, the area is not limited to the “s” field of the SDP header. For example, the area may be a “v” field, a “t” field or an SIP header.

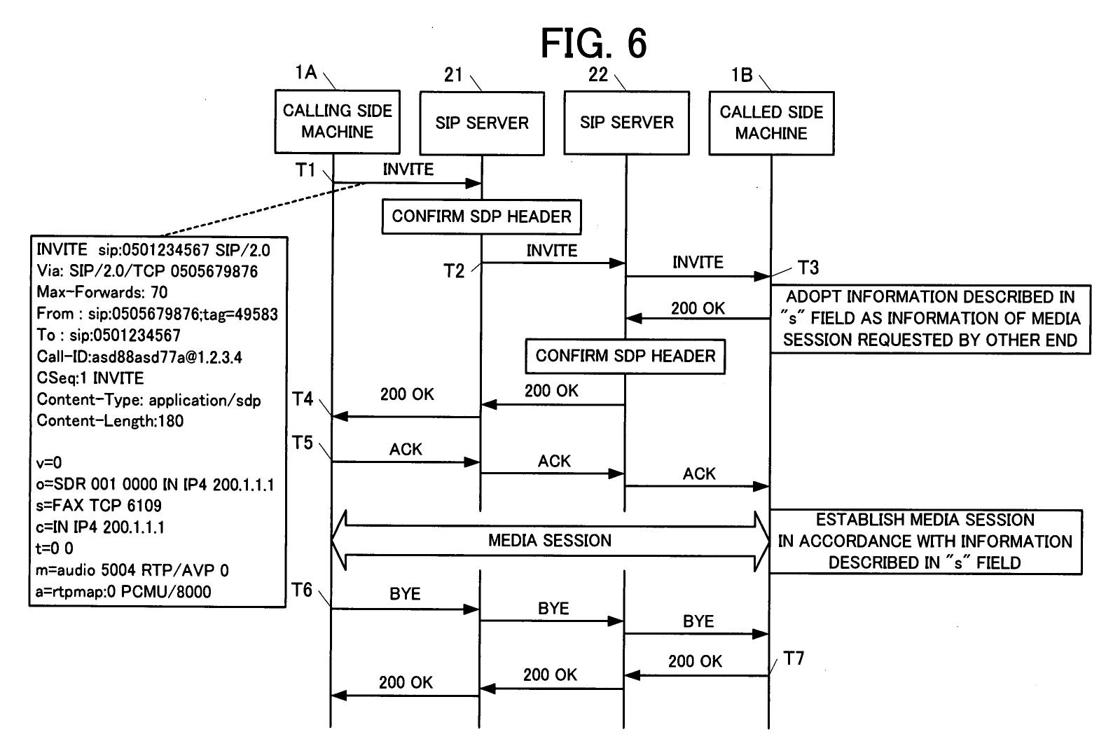

In the first preferred embodiment described above with reference to FIG. 3, one SIP server 20 is provided between the calling side machine 1A and the called side machine 1B. However, as illustrated in FIG. 6, at least two SIP servers imposing a restriction on an SDP header format may be provided between the calling side machine 1A and the called side machine 1B. Even in such a case, both the calling side machine 1A and the called side machine 1B may freely define the media session without receiving any restriction of the SIP server, and image data may be transmitted and received. That is, in a signaling message of the SIP exchanged between one another, the calling side machine 1A and the called side machine 1B respectively describe an SDP header in accordance with an SDP header format that conforms with an SIP server 21 to which the calling side machine 1A is connected directly and an SIP server 22 to which the called side machine 1B is connected directly. The calling side machine 1A and the called side machine 1B respectively describe the information relating to the media session, which is to be actually requested or replied to the other end, in the area not interfered respectively by the SIP servers 21 and 22, for example, the “s” field of the SDP header. Therefore, the preferred embodiment of the present invention can also be applied to a case where at least two SIP servers are provided between the calling side machine 1A and the called side machine 1B, and similar operation and effect can be achieved also in such a case.

### Second Preferred Embodiment

A description will be made of an MFP facsimile machine as an example of an image communication device according to a second preferred embodiment of the present invention. For example, the MFP facsimile machine includes an IP facsimile communication function for transmitting and receiving image data by using a call control protocol (for example, SIP) and a facsimile communication function of a G3 method or the like for transmitting and receiving image data through a PSTN. The MFP facsimile machine also includes a facsimile server function for providing a communication service of IP facsimile communication, a G3 facsimile communication or the like according to a request from a client device.

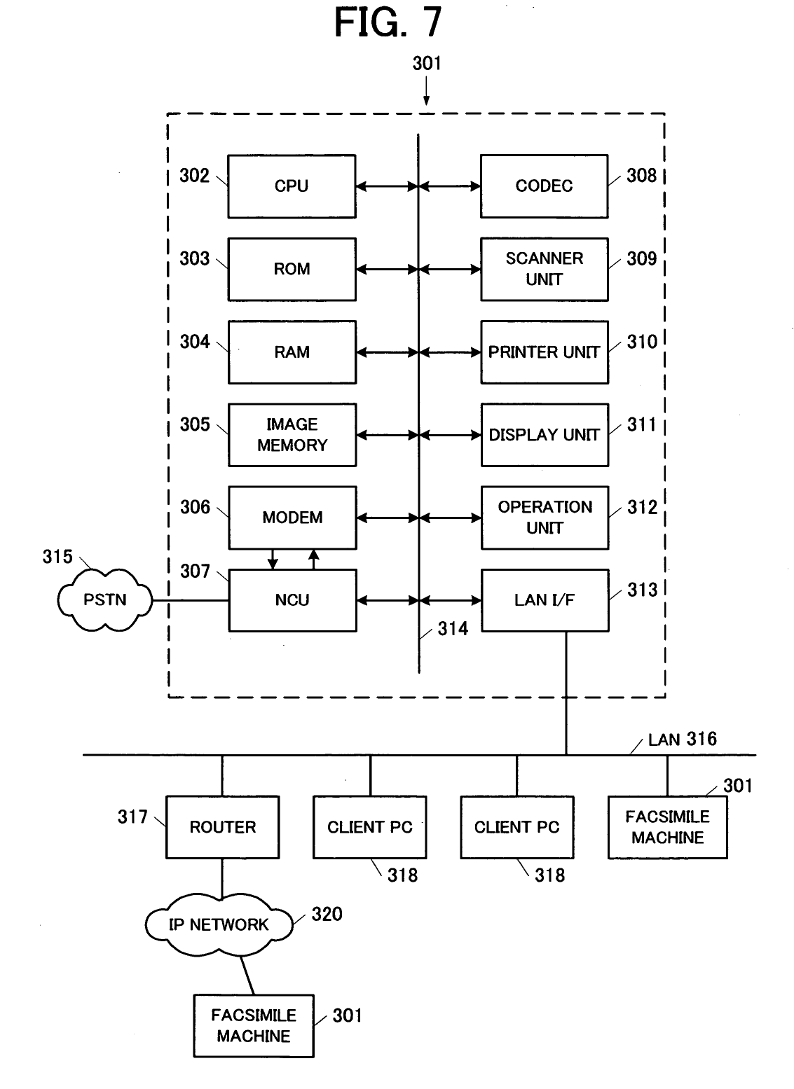

FIG. 7 illustrates an example of a configuration of a facsimile machine 301 according to the second preferred embodiment of the present invention. The facsimile machine 301 includes a CPU 302, a ROM 303, a RAM 304, an image memory 305, a MODEM 306, an NCU 307, a CODEC 308, a scanner unit 309, a printer unit 310, a display unit 311, an operation unit 312 and a LAN interface 313. Each of the units 302 through 313 is connected via a bus 314.

The CPU 302 functions as a control unit for controlling each of the units of the facsimile machine 301 in accordance with a control program stored in the ROM 303. The RAM 304 functions as a main memory and a working area or the like of the CPU 302. The RAM 304 stores a character string registered by being input by an operation performed from the operation unit 312, and communication history information. The communication history information is information relating to the communication carried out by the facsimile machine 301. For example, the communication history information is a communication time, a communication time period, a telephone number of another end, a character string to be described later, and communication error information. The image memory 305 stores image data compressed and encoded by the CODEC 308, for example. The image memory 305 stores image data received by the facsimile machine 301.

The MODEM 306 modulates transmission data and demodulates received data in accordance with, for example, the ITU-T Recommendation V.34 standard or anything similar to this. The NCU 307 is a communication network control device which carries out an operation for making and breaking a communication line with a PSTN 315. For example, when carrying out G3 facsimile transmission or reception, the NCU 307 establishes a connection between the MODEM 306 and the PSTN 315. When carrying out facsimile transmission or the like, the CODEC 308 compresses and encodes the image data. The CODEC 308 also decodes the received image data or the like.

The scanner unit 309 scans image data of an original document. For example, the scanner unit 309 includes a CCD color line image sensor, an A/D converter and an image processing circuit. The printer unit 310 picks up printing paper from a paper feed cassette and prints image data onto the printing paper.

The display unit 311 includes an LCD arranged adjacent to the operation unit 312, for example. The display unit 311 displays various pieces of screen information and a character string. The operation unit 312 includes various operation keys such as a start key, a character input key and a function key. The user performs various operations from the operation unit 312. The operation unit 312 functions as an input unit for inputting a character string. Further, the character string is not limited to hiragana, katakana (Japanese characters), kanji (Chinese character) or an alphabetic character. The character string may be any character string if the character string can be provided in a form of a text code. For example, the character string may be a numeral or a symbol.

The LAN interface 313 is an interface for establishing a connection between the facsimile machine 301 and a LAN 316. Through the LAN interface 313, the facsimile machine 301 transmits and receives image data to and from another machine also connected to the LAN 16. As illustrated in FIG. 7, a router 317, client Personal Computers (PCs) 318 and another facsimile machine 301 or the like are connected to the LAN 316. The facsimile machine 301 can carry out IP facsimile communication with the other facsimile machine 301 connected to the same LAN 316 and another facsimile machine 301 connected outside the LAN 316.

The facsimile machine 301 includes the TCP/IP, the SIP, the RTP, the SDP or the like. Accordingly, the facsimile machine 301 realizes a function for transmitting and receiving image data to and from another end after establishing a media session by the SIP. Further, in the second preferred embodiment, a description will be made of an example of the SIP as the call control protocol. However, the present invention shall not be limited to this example. A call control protocol other than the SIP may be adopted if the call control protocol exchanges a message prior to the establishment of the media session.

When an operation for transmitting image data by using the SIP is performed from the operation unit 308 or the client PC 318, the facsimile machine 301 can input any arbitrary character string or select a previously input character string. The input or selected character string is displayed on the display unit 311. The input or selected character string is described in a prescribed area in an SIP request message “INVITE”, which does not influence the establishment of the media session, and transmitted to the other end. The prescribed area, which does not influence the establishment of the media session, is an area where even when any arbitrary character string is described in such an area, a call control for establishing the media session is not influenced and a content of the media session to be established (for example, a media type, a CODEC type, a communication port number) is not influenced. For example, an “s” field, a “v” field and a “t” field or the like of the SDP header correspond to the prescribed area.

Meanwhile, the facsimile machine 301 of the other end determines whether or not a character string is described in the prescribed area in the “INVITE” received from the calling side facsimile machine 301. When a character string is described in the prescribed area, the facsimile machine 301 of the other end extracts the character string and displays the extracted character string on the display unit 311.

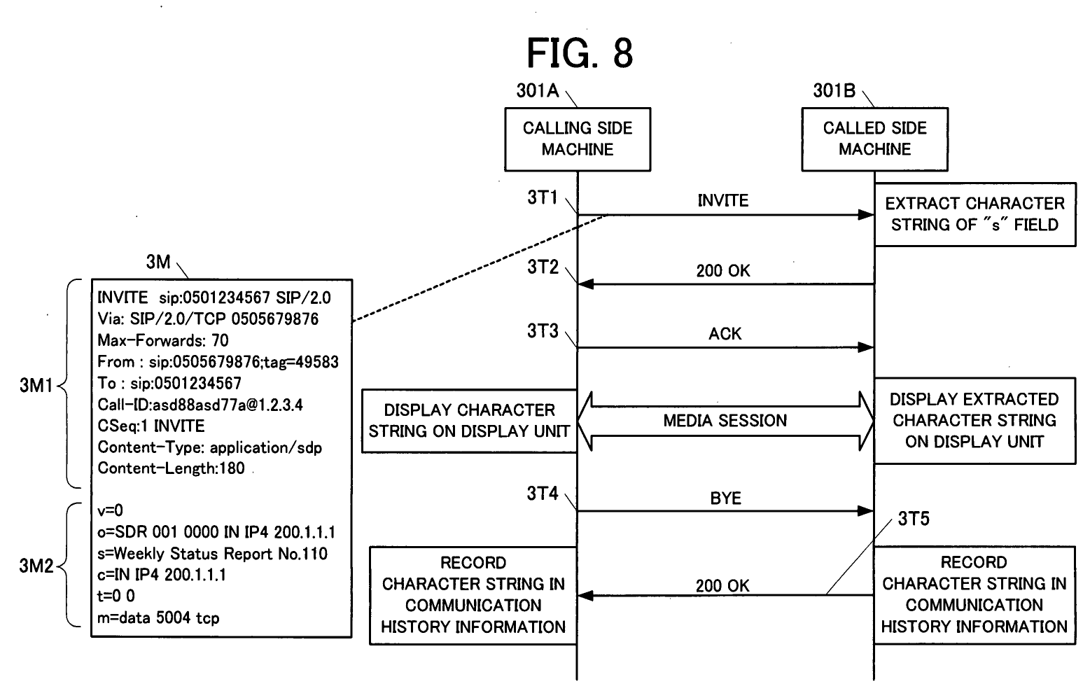

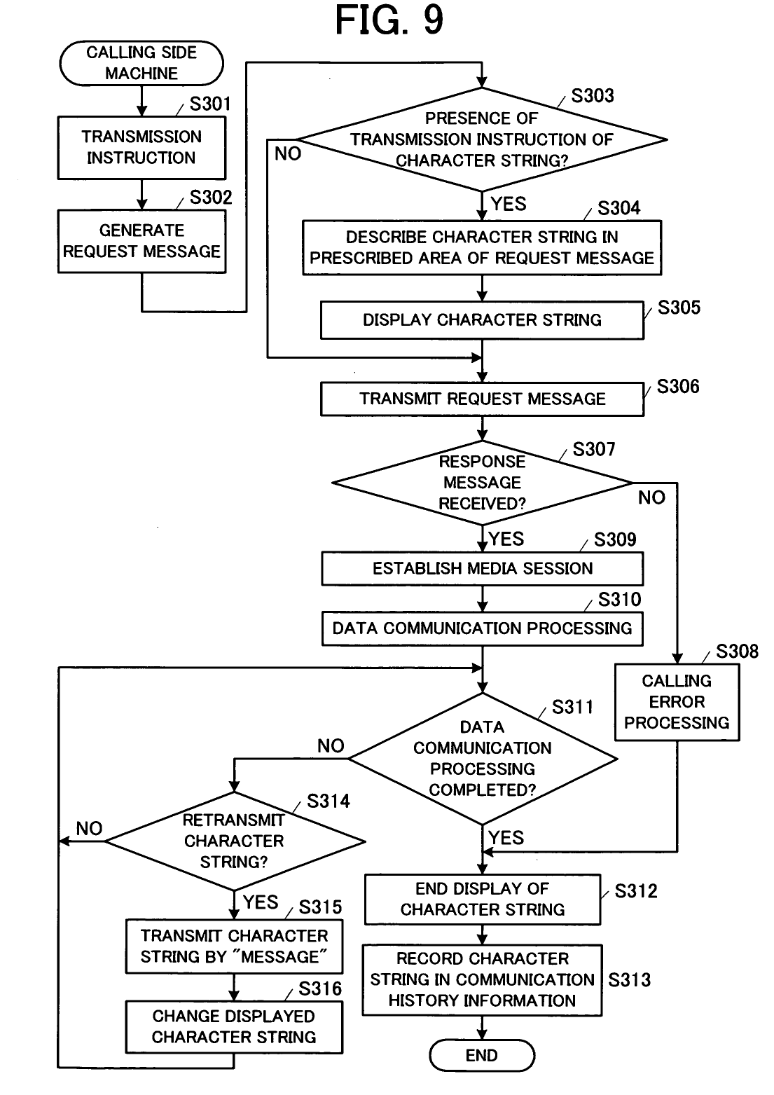

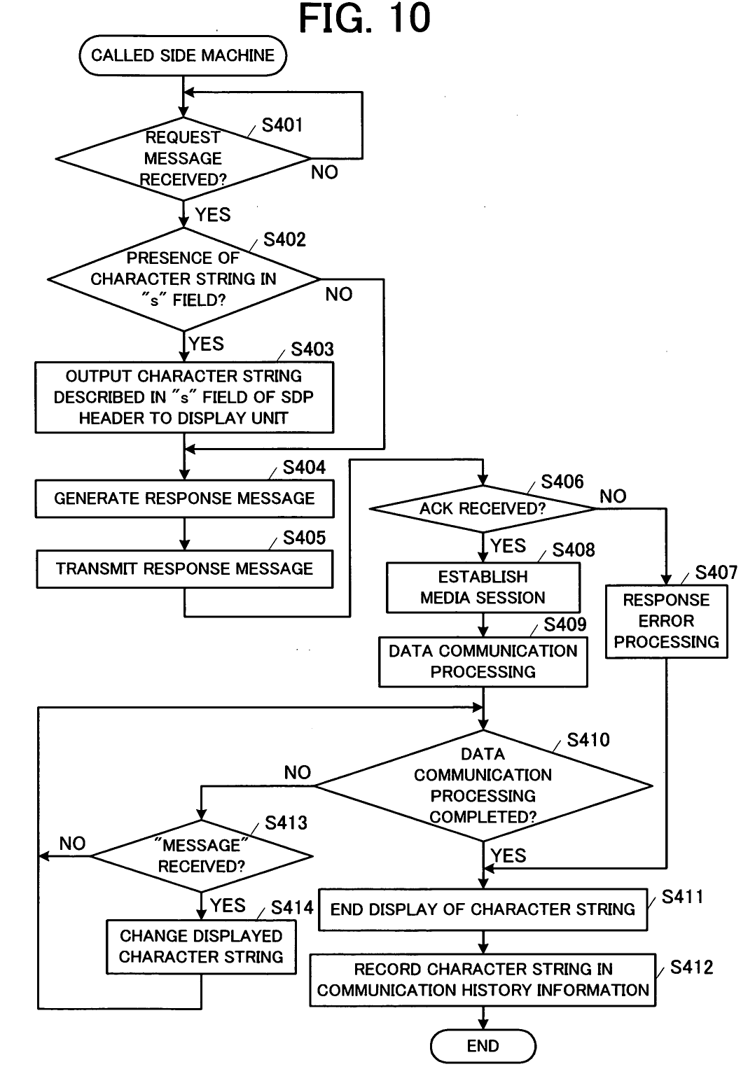

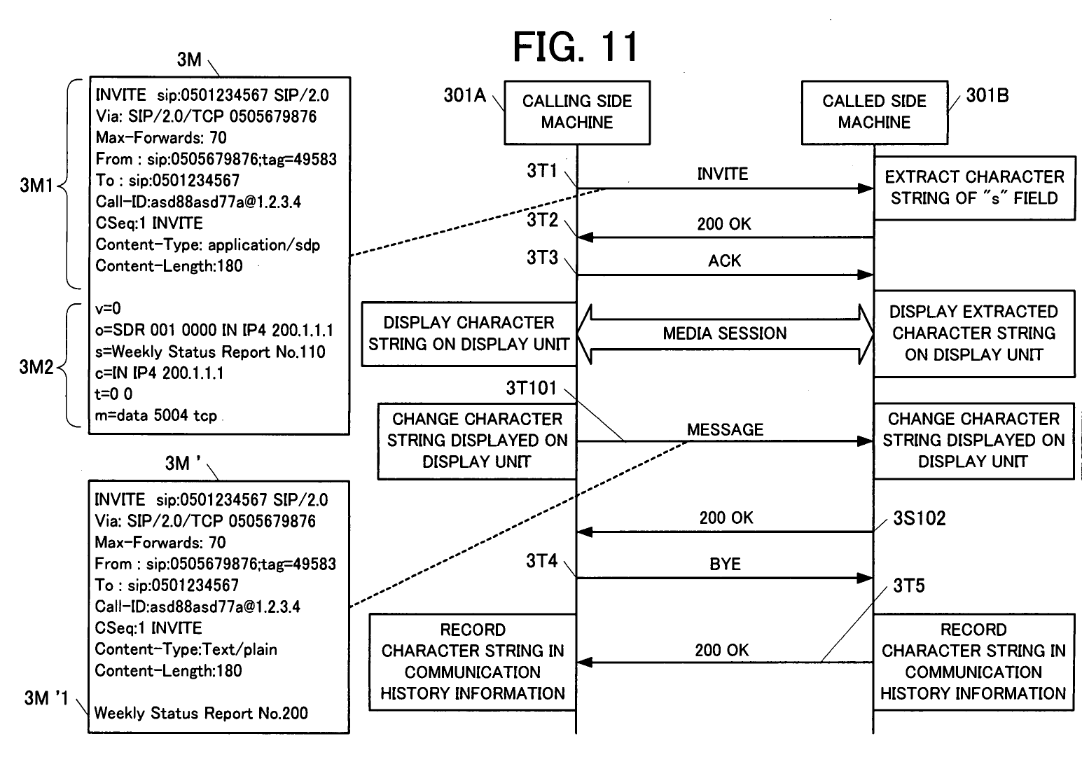

With reference to the sequence diagrams of FIG. 8 and FIG. 11 and the flowcharts of FIG. 9 and FIG. 10, a description will be made of a procession operation executed when the facsimile machines 301 establish a media session by exchanging a signaling message of the SIP and image data is transmitted and received. Further, the processing operation of the facsimile machines 301 to be described with reference to FIG. 8 through FIG. 11 is executed in accordance with a command issued by the CPU 302 based on a control program stored in the ROM 303.

In the following, for convenience of the description, the facsimile machine 301 to be a calling side will be referred to as a “calling side machine 301A” and the facsimile machine 301 to be a called side will be referred to as a “called side machine 301B”. Further, when carrying out a facsimile transmission operation from the client PC 318, the operation unit 312 of the facsimile machine 301 corresponds to an operation unit of the client PC 318, and the display unit 311 of the facsimile machine 301 corresponds to a display unit of the client PC 318.

The facsimile machine 301 accepts a transmission instruction operation of image data using the SIP and an input of any arbitrary character string to be transmitted. The character string is input by an input operation performed from the operation unit 308. A character string input previously from the operation unit 308 or the client PC 318 can be registered in a storage unit, such as the RAM 304, of the facsimile machine 301. In this case, when carrying out the transmission instruction operation, previously input and registered character strings are displayed on the display unit 311 so that a character string to be transmitted can be selected.

When the transmission instruction operation of the image data using the SIP and, according to a necessity of the user, an input operation of any arbitrary character string or a selecting operation of the character string are performed from the facsimile machine 301 (step S301), a request message “INVITE” requesting an establishment of a media session is generated (step S302). As illustrated in FIG. 8, a request message 3M includes an SIP header 3M1 and an SDP header 3M2. When the input operation or the selecting operation of the transmission character string has been performed at step S301 (step S303: YES), the character string designated to be transmitted is described in a prescribed area of the request message “INVITE” (step S304). The character string is output to the display unit 311 of the calling side machine 301A, and a content of the character string is displayed on the display unit 311 during communication (step S305). In the second preferred embodiment, as illustrated in FIG. 8, the character string is described in an “s” field of the SDP header, which is an area that does not influence the establishment of the media session (also an area not interfered by an SIP server). If the area where the character string is described is an area that does not influence the establishment of the media session, the area is not be limited to the “s” field of the SDP header. The area may be another field in the SDP header or in the SIP header.

When an input operation and a selecting operation of a character string have not been performed at step S301 (step S303: NO), the description processing of step S304 and the output processing of step S305 are not carried out and the process proceeds onto next step.

The calling side machine 301A transmits to the other end, the request message “INVITE” generated at step S302 or “INVITE” in which the arbitrary character string has been described in the “s” field of the request message “INVITE” at step S304 (step S306, 3T1). When the calling side machine 301A receives an error message without receiving a success response message as a response to the request message “INVITE” from the called side machine 301B, which is the other end (step S307: NO), the calling side machine 301A carries out a prescribed calling error processing (step S310). For example, the calling side machine 301A records communication error information in communication history information. Alternatively, the calling side machine 301A displays the received error message on the display unit 311, or prints out the error message from the printer unit 310.

Meanwhile, when the called side machine 301B receives the request message “INVITE” transmitted from the calling side machine 301A at step S306 (step S401: YES), the called side machine 301B determines whether or not a character string is described in an “s” field in the SDP header of the received request message “INVITE”, which is the prescribed area that does not influence the establishment of the media session (step S402). For example, when a character string “Weekly Status Report No. 110” is described in the “s” field as illustrated in FIG. 8 (step S402: YES), the called side machine 301B extracts the character string, outputs the extracted character string to the display unit 311 and displays the character string on the display unit 311 (step S403). Accordingly, the user of the called side machine 301B can grasp information relating to an original document during communication, for example, from the character string input by the user of the calling side machine 301A.

Next, the called side machine 301B generates a success response message “200 OK” as a response to the received request message “INVITE” (step S404). The called side machine 301B transmits the generated success response message “200 OK” to the calling side machine 301A (step S405). When the called side machine 301B receives an error message without receiving an acknowledgment “ACK” of a final response from the calling side machine 301A (step S406: NO), the called side machine 301B executes a prescribed response error processing (step S407). For example, the called side machine 301B records response error information in the communication history information. Alternatively, the called side machine 301B displays information indicating such a fact on the display unit 311 or prints out information indicating such a fact from the printer unit 310.

When the calling side machine 301A receives the success response message “200 OK” transmitted by the called side machine 301B at step S405 (step S307: YES, 3T2), the calling side machine 301A transmits a final response acknowledgement “ACK” to the called side machine 301B. The called side machine 301B receives the acknowledgment “ACK” (3T3, step S406: YES). Then, a media session is established between the calling side machine 301A and the called side machine 301B (step S309, step S408), and a data communication processing of image data or the like starts (step S310, step S409). After the data communication processing has been completed, an end request message “BYE” of the media session is transmitted from the calling side machine 301A to the called side machine 301B (3T4). After a response message “200 OK” is returned from the called side machine 301B to the calling side machine 301A (3T5), the media session is disconnected.

When the calling side machine 301A transmits “BYE” and receives “200 OK”, a determination is made that the data communication processing has been completed (step S311: YES). The output of the character string to the display unit 311 is ended (step S312). The calling side machine 301A records and stores the character string, which has been described in “INVITE” and transmitted to the other end, as communication history information (step S313).

Meanwhile, when the called side machine 301B receives “BYE” and transmits “200 OK”, a determination is made that the data communication processing has been completed (step S410: YES). The output of the character string to the display unit 311 is ended (step S411). The called side machine 301B records and stores the character string, which has been extracted from the “s” field of the “INVITE”, as communication history information (step S412).

When a media session is established between the calling side machine 301A and the called side machine 301B and a data communication processing is being carried out on the established media session, if an input operation of any arbitrary character string or a selecting operation of a registered character string is performed additionally at the calling side machine 301A, the calling side machine 301A accepts the operation as a retransmission instruction of the character string (step S314: YES). Then, as illustrated in FIG. 11, the calling side machine 301A transmits to the called side machine 301B, the character string designated by the input operation or the selecting operation by a request message 3M′ of the SIP capable of transmitting any arbitrary character string to the other end, for example, “MESSAGE” of an SIP method (step S315, 3T101). In place of the character string being output on the display unit 311 of the calling side machine 301A, the calling side machine 301A outputs the character string transmitted by the “MESSAGE” at step S315 to the display unit 311 and displays the character string on the display unit 311 (step S316). Then, the process returns to step S311. When the data communication processing is completed (step S311: YES), the output and the display of the character string are ended (step S312). Then, the character string transmitted to the other end the last time is recorded and stored as the communication history information in the communication history information (step S313). When the “MESSAGE” has not been transmitted, the character string transmitted to the other end the last time is the character string, which has been described in the “s” field of the SDP header of “INVITE” and transmitted to the other end. When the “MESSAGE” has been transmitted during the data communication processing, the character string transmitted to the other end the last time is the character string described in a message body of the “MESSAGE” transmitted the last time.

Meanwhile, when the called side machine 301B receives “MESSAGE” during the data communication processing (step S413: YES), in place of the character string being output on the display unit 311, the called side machine 301B outputs the character string received by the “MESSAGE” (a character string described in the message body) to the display unit 311 and displays the character string on the display unit 311 (step S414). When the data communication processing completes (step S410: YES), the output and the display of the character string are ended (step S411). The called side machine 301B records and stores the character string received from the other end the last time as the communication history information in the communication history information (step S412). When the “MESSAGE” has not been received, the character string received from the other end the last time is the character string described in the “s” field of the SDP header of “INVITE”. When the “MESSAGE” has been received during the data communication processing, the character string received from the other end the last time is the character string described in the message body of the “MESSAGE” received the last time. As described above, according to the facsimile machine 301 of the second preferred embodiment of the present invention, when a character string is transmitted to another end and the character string is being output at the other end, the character string may be changed while the media session is established. The content of the character string may be changed for any number of times while the media session is established.

Further, in the second preferred embodiment of the present invention, a description has been made of the output to the display unit 311 as an example of an output form of the character string at steps S305, S316, S403 and S414. However, if the output form can notify the content of the character string to the user, the output form is not limited to the output to the display unit 311. For example, the character string may be output to the printer unit 310 and printed out. Alternatively, a conversion unit for converting the content of the character string into voice data may be provided, and the character string may be notified by voice from a voice output unit. Alternatively, the character string may be output to a device other than the facsimile machine 301. When the output is not continuous like a printing process, the output can be carried out again.

At steps S313 and S412, the character string transmitted and received the last time is recorded and stored as the communication history information. However, all of the character strings exchanged between the calling side machine 301A and the called side machine 301B may be recorded.

As described above, according to the second preferred embodiment of the present invention, when the facsimile machine 301 establishes a media session by the SIP and carries out data communication of the image data with the other end, any arbitrary character string is transmitted and received independently from the media session. The character string can be displayed on the display unit 311 of the calling side machine 301A and the called side machine 301B. For example, when information relating to a communication original document is input from the calling side as a character string, the user of the calling side machine and the user of the called side machine can grasp the information relating to the original document currently being communication by looking at the character string displayed on the display unit 311 during the communication. When the user of the calling side machine periodically carries out facsimile transmission of periodicals or the like to a customer, the user may input a volume of the periodicals (for example, a character string “No. 110” described in the “s” field of the SDP header 3M2, and a character string “No. 200” described in a message body 3M′1 of the “MESSAGE” in FIG. 11) as a character string. Accordingly, the input volume of the periodicals is recorded and stored as reception history information of the called side machine 301B of the customer. As a result, by referring to the reception history information, the customer can easily confirm whether or not an original document of all of the periodicals has been received every week.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An image communication device, comprising:
means for storing a Session Description Protocol (SDP) header format that conforms to a server of a carrier to which the image communication device is connected;
a first describing means for describing an SDP header of a request message to be transmitted in accordance with the SDP header format stored in the means for storing;
a second describing means for describing information relating to a media session to be requested to a communication device of another end in a prescribed area, not interfered by the server, in the request message;
means for establishing the media session by exchanging a message of a call control protocol with the communication device of the other end; and
means for transmitting image data to the communication device of the other end in accordance with the information relating to the media session in the media session established by the means for establishing.

2. The image communication device according to claim 1, wherein the prescribed area, where the second describing means describes the information relating to the media session, is a specific field of the Session Description Protocol (SDP) header described by the first describing means.

3. The image communication device according to claim 2, wherein the specific field is an s field of the Session Description Protocol (SDP) header.

4. The image communication device according to claim 1, wherein the information relating to the media session is a media type.

5. The image communication device according to claim 1, wherein the information relating to the media session is a port number.

6. An image communication device, comprising:
means for establishing a media session by exchanging a message of a call control protocol with a communication device of another end;
means for receiving image data on the media session established by the means for establishing; and
means for adopting information described in a prescribed area, not interfered by a server controlling a call control, in the received request message as information relating to the media session requested by the communication device of the other end.

7. The image communication device according to claim 6, wherein the prescribed area, not interfered by the server, is a specific field of a Session Description Protocol (SDP) header in the received request message.

8. The image communication device according to claim 7, wherein the specific field is an s field of the Session Description Protocol (SDP) header.

9. The image communication device according to claim 6, wherein the information relating to the media session is a media type.

10. The image communication device according to claim 6, wherein the information relating to the media session is a port number.

11. An image communication device, comprising:
means for establishing a media session by exchanging a message of a call control protocol with a communication device of another end;
means for transmitting image data in the established media session;
means for inputting any arbitrary character string;
means for describing the input character string in a prescribed area, not influencing the establishment of the media session, in a message requesting the establishment of the media session; and
means for transmitting the message including the character string to the communication device of the other end.

12. The image communication device according to claim 11, further comprising means for storing the character string described in the prescribed area as communication history information.

13. The image communication device according to claim 11, wherein the prescribed area is an s field of a Session Description Protocol (SDP) header.

14. An image communication device, comprising:
means for establishing a media session by exchanging a message of a call control protocol with a communication device of another end;
means for receiving image data in the established media session;
means for extracting a character string described in a prescribed area, not influencing the establishment of the media session, in a message requesting to establish the media session received from the other end; and
means for outputting the extracted character string.

15. The image communication device according to claim 14, further comprising means for storing the character string described in the prescribed area as communication history information.

16. The image communication device according to claim 14, wherein the prescribed area is an s field of a Session Description Protocol (SDP) header.
